(19) United States
(12) Patent Application Publication
(10) Pub. No.: US 2024/0405196 A1
(43) Pub. Date: Dec. 5, 2024

(54) BATTERY CELLS INCLUDING HYBRID ANODE ELECTRODES

(71) Applicant: GM GLOBAL TECHNOLOGY OPERATIONS LLC, Detroit, MI (US)

(72) Inventors: Anita LI, Ann Arbor, MI (US); Meng JIANG, Rochester Hills, MI (US); Xiaosong HUANG, Novi, MI (US); Mark W. VERBRUGGE, Sonoma, CA (US)

(21) Appl. No.: 18/325,491

(22) Filed: May 30, 2023

(51) Int. Cl. H01M 4/36; H01M 4/131; H01M 4/133; H01M 4/134; H01M 4/38; H01M 4/485; H01M 4/587; H01M 10/0525

(52) U.S. Cl. CPC H01M 4/364; H01M 4/131; H01M 4/133; H01M 4/134; H01M 4/386; H01M 4/485; H01M 4/587; H01M 10/0525; H01M 2004/027

(57) ABSTRACT

An anode electrode for a battery cell includes an anode current collector. An anode active material layer comprising a first active material comprising silicon and a second active material comprising at least one of lithium titanium oxide (LTO) and a LTO derivative including LTO doped with a transition metal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including hybrid anode electrodes.

Electric vehicles such as battery electric vehicles and hybrid vehicles are powered by a battery pack including one or more battery modules each having one or more battery cells. The battery cells include anode electrodes, cathode electrodes, and separator layers. The anode electrodes typically include anode active layers arranged on one or both sides of anode current collectors. The cathode electrodes typically include cathode active layers arranged on one or both sides of cathode current collectors.

### SUMMARY

An anode electrode for a battery cell includes an anode current collector. An anode active material layer comprising a first active material comprising silicon and a second active material comprising at least one of lithium titanium oxide (LTO) and a LTO derivative including LTO doped with a transition metal.

In other features, the first active material includes one or more materials selected from a group consisting of pure silicon, silicon carbon (SIC) composite, silicon oxide (SiOₓ), lithium silicon oxide (LiSiOₓ), silicon alloy, and combinations thereof.

In other features, the anode active material layer further comprises binder and a conductive additive. The anode active material layer comprises active material including the first active material and the second active material in a range from 80% wt to 96% wt of the anode active material layer, a binder in a range from 2% wt to 10% wt of the anode active material layer, and a conductive additive in a range from 2% wt to 10% wt of the anode active material layer.

In other features, the first active material and the second active material are one of homogenously mixed with the binder and the conductive additive in a same layer arranged on the anode current collector, homogenously mixed in different layers with the binder and the conductive additive and arranged in an alternating pattern perpendicular to the anode current collector, and homogenously mixed in different layers with the binder and the conductive additive and stacked and arranged parallel to the anode current collector.

In other features, the anode active material layer further comprises a third active material including hard carbon. The first active material, the second active material, and the third active material are one of homogenously mixed with binder and a conductive additive in a same layer arranged on the anode current collector, homogenously mixed in different layers with the binder and the conductive additive and arranged in an alternating pattern perpendicular to the anode current collector, and homogenously mixed in different layers with the binder and the conductive additive and stacked and arranged parallel to the anode current collector.

In other features, the first active material comprises 5 wt % to 20 wt % of the active material in the anode active material layer. The first active material comprises 5 wt % to 50 wt % of the active material in the anode active material layer. The first active material comprises 5 wt % to 80 wt % of the active material in the anode active material layer.

An anode electrode for a battery cell comprises an anode current collector. An anode active material layer comprises a first active material comprising silicon and a second active material comprising titanium niobium oxide (TNO).

In other features, the first active material includes one or more materials selected from a group consisting of pure silicon, silicon carbon (SiC) composite, silicon oxide (SiOₓ), lithium silicon oxide (LiSiOₓ), silicon alloy, and combinations thereof. The anode active material layer further comprises a binder and a conductive additive. The anode active material layer comprises active material including the first active material and the second active material in a range from 80% wt to 96% wt of the anode active material layer, a binder in a range from 2% wt to 10% wt of the anode active material layer, and a conductive additive in a range from 2% wt to 10% wt of the anode active material layer.

In other features, the first active material and the second active material are one of homogenously mixed with the binder and the conductive additive in a same layer arranged on the anode current collector, homogenously mixed in different layers with the binder and the conductive additive and arranged in an alternating pattern perpendicular to the anode current collector, and homogenously mixed in different layers with the binder and the conductive additive and stacked and arranged parallel to the anode current collector.

In other features, the anode active material layer further comprises a third active material including hard carbon and a fourth active material comprising graphite.

In other features, the first active material, the second active material, the third active material, and the fourth active material are one of homogenously mixed with the binder and the conductive additive in a same layer arranged on the anode current collector, homogenously mixed in different layers with the binder and the conductive additive and arranged in an alternating pattern perpendicular to the anode current collector, and homogenously mixed in different layers with the binder and the conductive additive and stacked and arranged parallel to the anode current collector.

In other features, the first active material comprises 5 wt % to 80 wt % of the active material in the anode active material layer.

An anode electrode for a battery cell includes an anode current collector. An anode active material layer comprises a first active material comprising silicon; a second active material comprising graphite; and a third active material comprising hard carbon.

In other features, the first active material includes one or more materials selected from a group consisting of pure silicon, silicon carbon (SIC) composite, silicon oxide (SiOₓ), lithium silicon oxide (LiSiOₓ), silicon alloy, and combinations thereof.

In other features, the anode active material layer further comprises a binder and a conductive additive. The anode active material layer comprises active material including the first active material, the second active material, and the third active material in a range from 80% wt to 96% wt of the anode active material layer, the binder in a range from 2% wt to 10% wt of the anode active material layer, and the conductive additive in a range from 2% wt to 10% wt of the anode active material layer. The first active material comprises 5% wt to 80% wt of the active material.

In other features, the first active material, the second active material, and the third active material are one of homogenously mixed with a binder and a conductive additive in a same layer arranged on the anode current collector, homogenously mixed in different layers with the binder and the conductive additive and arranged in an alternating pattern perpendicular to the anode current collector, and homogenously mixed in different layers with the binder and the conductive additive and stacked and arranged parallel to the anode current collector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including hybrid anode electrodes according to the present disclosure;

FIGS. 2 to 11 are side cross-sectional views of examples of hybrid anode electrodes according to the present disclosure; and

FIG. 12 is a flowchart of an example of a method for manufacturing the hybrid anode electrodes and battery cells including the hybrid anode electrodes according to the present disclosure.

In the drawings, reference numbers may be reused to identify similar and/or identical elements.

### DETAILED DESCRIPTION

While the present disclosure describes hybrid anode electrodes and battery cells including hybrid anode electrodes used in vehicle applications, the hybrid anode electrodes and the battery cells can be used in stationary or other types of applications.

The present disclosure relates to hybrid anode electrodes and/or battery cells including the hybrid anode electrodes. In some examples, the hybrid anode electrodes comprise a mixture active materials including silicon-based anode materials and one or more of Li₄Ti₅O₁₂ (LTO) and/or LTO derivatives, hard carbon, graphite, and/or a titanium niobium oxide (TNO) (e.g., TiNb₂O₇ and/or Ti₂Nb₂O₉). As used herein, silicon-based anode materials include pure silicon, silicon carbon (SIC) composite, silicon oxide (SiOₓ), lithium silicon oxide (LiSiOₓ), silicon alloy, other anode materials including silicon, and combinations thereof. In some examples, SiC comprises a composite including carbon-coated silicon or silicon embedded in carbon. The LTO derivatives include LTO (Li₄Ti₅NbO₁₂) doped with a transition metal (e.g., niobium-doped LTO, chromium-doped LTO, etc.).

The hybrid anode electrodes improve fast charge capabilities of the battery cells. The hybrid anode electrodes also mitigate lithium plating issues during fast charging, as compared to Si-based anode electrodes and/or Si/graphite-based anode electrodes.

Fast charge capability of lithium ion battery cells is an important feature for electrical vehicle (EV) applications. However, there is a risk of lithium (Li) plating for anode electrodes including graphite and/or Si/graphite when fast charging is used. Graphite has a charge potential close to 0 V. For example, by combining the Si-based anode materials with LTO and/or LTO derivatives and one or more of graphite hard carbon, and/or TNO, the fast charge capability of the battery cell improves and the lithium plating issue is mitigated. The LTO and/or LTO derivatives, hard carbon, and/or TNO have higher charge potentials than graphite.

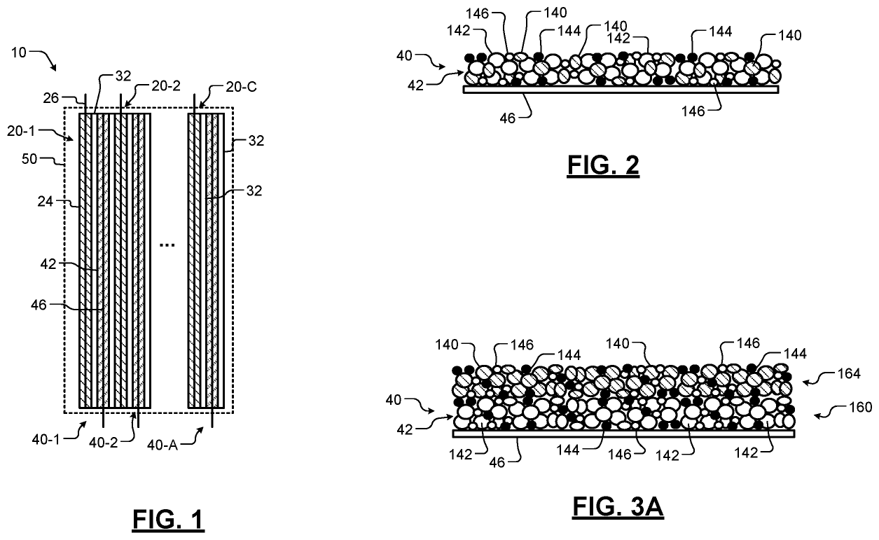

Referring now to FIG. 1, a battery cell 10 includes cathode electrodes 20, hybrid anode electrodes 40, and separator layers 32 arranged in a predetermined sequence in an enclosure 50. The cathode electrodes 20-1, 20-2, . . . , and 20-C (where C is an integer greater than one) include cathode active layers 24 arranged on one or both sides of cathode current collectors 26. The hybrid anode electrodes 40-1, 40-2, . . . , and 40-A (where A is an integer greater than one) include hybrid anode active layers 42 arranged on one or both sides of the anode current collectors 46. In some examples, the hybrid anode active layers 42 comprise coatings including two or more active materials, a conductive additive, and/or a binder.

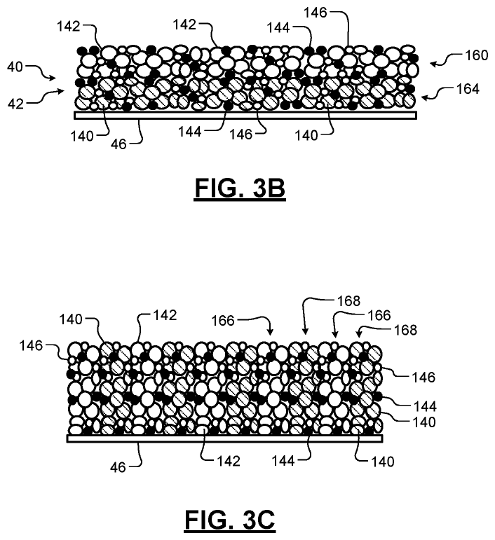

Referring now to FIGS. 2 and 3, the hybrid anode active layers 42 of the hybrid anode electrode 40 include anode active materials including Si-based particles 140 and LTO particles 142 made of LTO and/or LTO derivatives. The hybrid anode active layers 42 further include binder 144 and a conductive additive 146. In some examples, the binder 144 comprises polyvinylidene difluoride (PVDF), although other binders can be used. In some examples, the conductive additive 146 comprises carbon black, acetylene black, or another conductive filler. In some examples, the various materials in the hybrid anode electrodes 40 are homogeneously mixed as shown in FIG. 2. In some examples, the mixture is used to form a slurry, paste, dough, and/or dry powder that is coated onto one or both sides of the anode current collector 46.

In FIG. 3A, the hybrid anode active layers 42 of the hybrid anode electrode 40 include a first layer 160 arranged adjacent to the anode current collector 46 and a second layer 164 arranged adjacent to the first layer 160. In some examples, the first layer 160 includes the LTO particles 142, the binder 144, and the conductive additive 146 that are homogenously mixed. The second layer 164 includes the Si-based particles 140, the binder 144, and the conductive additive 146 that are homogenously mixed. As can be appreciated, the second layer 164 may be arranged adjacent to the anode current collector 46 and the first layer 160 can be arranged adjacent to the second layer 164 as shown in FIG. 3B.

In FIG. 3C, the hybrid anode active layers 42 of the hybrid anode electrode 40 include first layers 166 extending perpendicular to a longitudinal direction of the anode current collector 46 and second layers 168 interleaved between the first layers 166 and extending perpendicular to the longitudinal direction of the anode current collector 46. The first layers 166 include the LTO particles 142, the binder 144, and the conductive additive 146. The second layers 164 includes the Si-based particles 140, the binder 144, and the conductive additive 146.

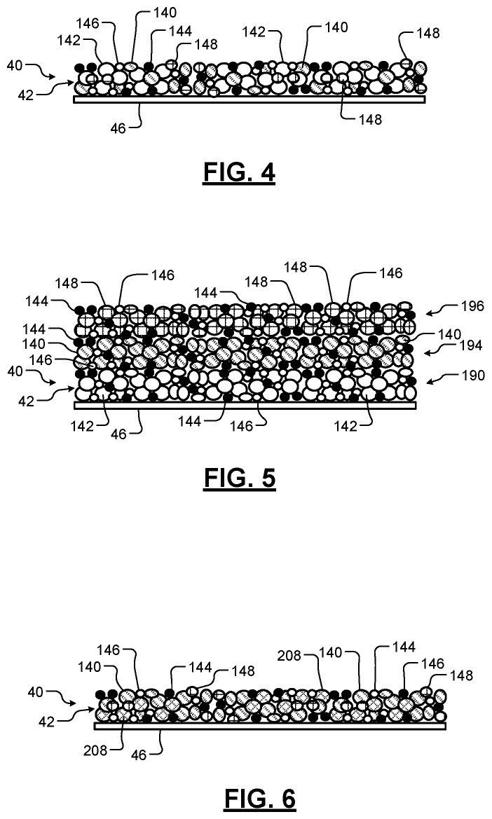

Referring now to FIGS. 4 and 5, the hybrid anode active layers 42 of the hybrid anode electrode 40 include the Si-based particles 140, the LTO particles 142, and hard carbon 148. The hybrid anode active layers 42 further include the conductive additive 146 and the binder 144. In some examples, the materials in the anode electrode are homogeneously mixed as shown in FIG. 4. In some examples, the mixture forms a slurry, paste, dough, and/or dry powder that is coated onto one or both sides of the anode current collector 46.

In FIG. 5, the hybrid anode active layers 42 of the hybrid anode electrode 40 include a first layer 190 arranged adjacent to the anode current collector 46, a second layer 194 arranged adjacent to the first layer 190, and a third layer 196 arranged adjacent to the second layer 194. In some examples, the first layer 190 includes the LTO particles 142, the binder 144, and the conductive additive 146 that are homogenously mixed. The second layer 194 includes the Si-based particles 140, the binder 144, and the conductive additive 146 that are homogenously mixed. The third layer 196 includes the hard carbon 148, the binder 144, and the conductive additive 146 that are homogenously mixed. As can be appreciated, the order of the layers 190, 194 and 196 can be varied. Alternately, the layers 190, 194 and 196 can be arranged perpendicular to the anode current collector 46 and alternate in a manner similar to FIG. 3C (and/or other varied patterns of the layers can be used).

Referring now to FIGS. 6 and 7, the hybrid anode active layers 42 of the hybrid anode electrode 40 include the Si-based particles 140, graphite 208, and the hard carbon 148. The hybrid anode active layers 42 further include the conductive additive 146 and the binder 144. In some examples, the materials in the anode electrode are homogeneously mixed as shown in FIG. 6. In some examples, the mixture forms a slurry, paste, dough, and/or dry powder that is coated onto one or both sides of the anode current collector 46.

In FIG. 7, the hybrid anode active layers 42 of the hybrid anode electrode 40 include a first layer 210 arranged adjacent to the anode current collector 46, a second layer 214 arranged adjacent to the first layer 160, and a third layer 218 arranged adjacent to the second layer 214. In some examples, the first layer 210 includes the hard carbon 148, the binder 144, and the conductive additive 146 that are homogenously mixed. The second layer 214 includes the Si-based particles 140, the binder 144, and the conductive additive 146 that are homogenously mixed. The third layer 216 includes the graphite 208, the binder 144, and the conductive additive 146 that are homogenously mixed. As can be appreciated, the order of the layers 210, 214 and 218 can be varied. Alternately, the layers 210, 214 and 218 can be arranged perpendicular to the anode current collector 46 and alternate in a manner similar to FIG. 3C (and/or other varied patterns of the layers can be used).

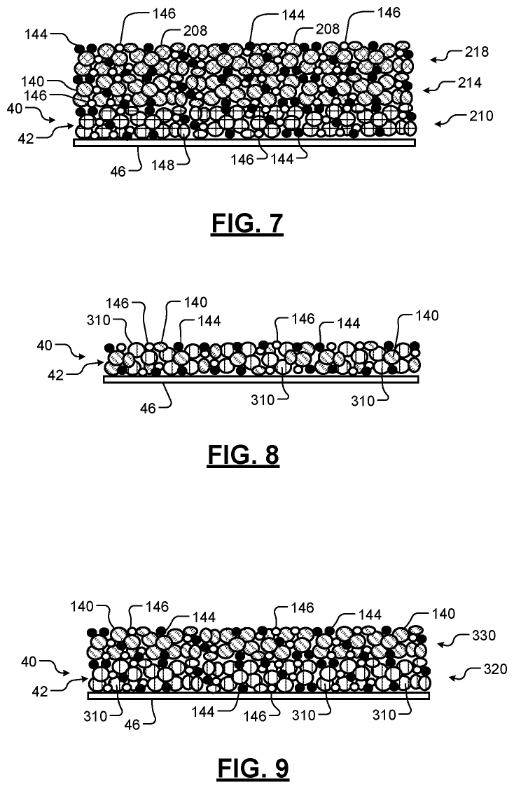

Referring now to FIGS. 8 and 9, the hybrid anode active layers 42 of the hybrid anode electrode 40 include the Si-based particles 140 and titanium niobium oxide (TNO) 310 (e.g., TiNb₂O₇ and/or Ti₂Nb₂O₉). The hybrid anode active layers 42 further include the conductive additive 146 and the binder 144. In some examples, the materials in the anode electrode are homogeneously mixed as shown in FIG. 8. In some examples, the mixture forms a slurry, paste, dough, and/or dry powder that is coated onto one or both sides of the anode current collector 46.

In FIG. 9, the hybrid anode active layers 42 of the hybrid anode electrode 40 include a first layer 320 arranged adjacent to the anode current collector 46 and a second layer 324 arranged adjacent to the first layer 320. In some examples, the first layer 320 includes the TNO 310, the binder 144, and the conductive additive 146 that are homogenously mixed. The second layer 324 includes the Si-based particles 140, the binder 144, and the conductive additive 146 that are homogenously mixed. As can be appreciated, the order of the layers 320 and 330 can be varied. Alternately, the layers 320 and 330 can be arranged perpendicular to the anode current collector 46 and alternate in a manner similar to FIG. 3C (and/or other varied patterns of the layers can be used).

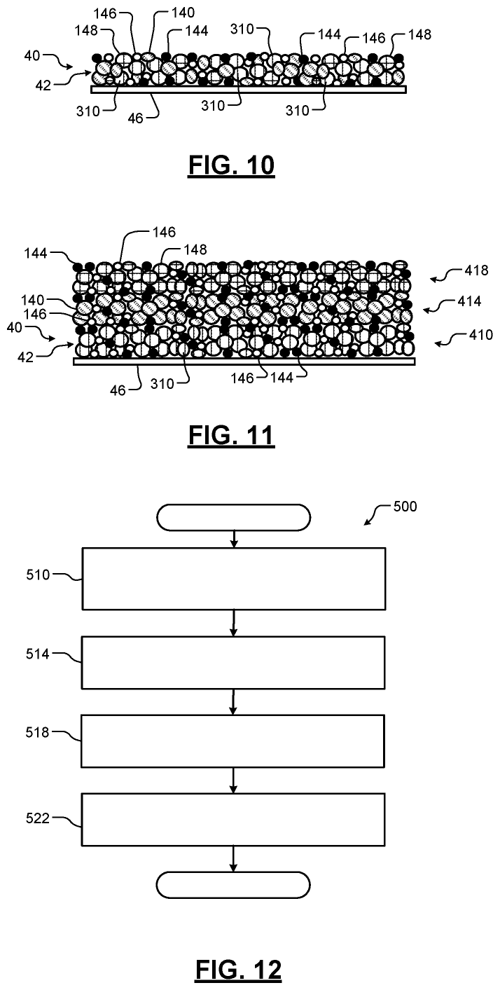

Referring now to FIGS. 10 and 11, the hybrid anode active layers 42 of the hybrid anode electrode 40 include the Si-based particles 140, the TNO 310, and the hard carbon 148. The hybrid anode active layers 42 further include the conductive additive 146 and the binder 144. In some examples, the materials in the anode electrode are homogeneously mixed as shown in FIG. 10. In some examples, the mixture forms a slurry, paste, dough, and/or dry powder that is coated onto one or both sides of the anode current collector 46.

In FIG. 11, the hybrid anode active layers 42 of the hybrid anode electrode 40 include a first layer 410 arranged adjacent to the anode current collector 46, a second layer 414 arranged adjacent to the first layer 410, and a third layer 418 arranged adjacent to the second layer 414. In some examples, the first layer 410 includes the TNO 310, the binder 144, and the conductive additive 146 that are homogenously mixed. The second layer 214 includes the Si-based particles 140, the binder 144, and the conductive additive 146 that are homogenously mixed. The third layer 216 includes the hard carbon 148, the binder 144, and the conductive additive 146 that are homogenously mixed. As can be appreciated, the order of the layers 410, 414, and 418 can be varied. Alternately, the layers 410, 414, and 418 can be arranged perpendicular to the anode current collector 46 and alternate in a manner similar to FIG. 3C (and/or other varied patterns of the layers can be used).

Referring now to FIG. 12, a method 500 for manufacturing hybrid anode electrodes and/or battery cells including hybrid anode electrodes is shown. At 510, one or more anode active materials are mixed with binder, solvent and/or conductive additives into a slurry, paste, dough, and/or dry powder. At 514, the slurry, paste, dough, and/or dry powder is applied onto one or both sides of an anode current collector. For examples, the slurry can be applied to the anode current collector such as a metal foil in a roll-to-roll manufacturing process.

At 518, heat and/or pressure may be applied. At 522, one or more anode electrodes, cathode electrodes, and separators are arranged in a predetermined sequence to form a battery cell.

In some examples, the anode active material layers comprise the active materials in a range from 80% to 96%, the binder in a range from 2% to 10%, and the conductive carbon in a range from 2% to 10%. In some examples, the anode active material comprises silicon-based particles in a range from 5% to 80% and a remainder of the anode active material in a range from 20% to 95% comprising LTO, graphite, hard carbon, and/or TNO. In some examples, the anode active material comprises silicon in a range from 5% to 50% and a remainder of the anode active material in a range from 50% to 95% comprising LTO, graphite, hard carbon, and/or TNO. In some examples, the anode active material comprises silicon in a range from 5% to 20% and a remainder of the anode active material in a range from 80% to 95% comprising LTO, graphite, hard carbon, and/or TNO.

In some examples, the anode electrodes can be manufactured using a layer-by-layer coating process using single die head or comma bar. In other examples, a multiple die head coats multiple layers at the same time. In other examples, a dry process similar to powder coating is used (the coating is statically charged and the anode current collector is grounded). In other examples, 3D printing is used supply a multi-layer coating onto the anode current collector.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An anode electrode for a battery cell, comprising:
an anode current collector; and
an anode active material layer comprising:
a first active material comprising silicon; and
a second active material comprising at least one of lithium titanium oxide (LTO) and a LTO derivative including LTO doped with a transition metal.

2. The anode electrode of claim 1, wherein the first active material includes one or more materials selected from a group consisting of pure silicon, silicon carbon (SiC) composite, silicon oxide (SiOₓ), lithium silicon oxide (LiSiOₓ), silicon alloy, and combinations thereof.

3. The anode electrode of claim 1, wherein:
the anode active material layer further comprises binder and a conductive additive, and
the anode active material layer comprises:
active material including the first active material and the second active material in a range from 80% wt to 96% wt of the anode active material layer,
a binder in a range from 2% wt to 10% wt of the anode active material layer, and
a conductive additive in a range from 2% wt to 10% wt of the anode active material layer.

4. The anode electrode of claim 3, wherein the first active material and the second active material are one of:
homogenously mixed with the binder and the conductive additive in a same layer arranged on the anode current collector,
homogenously mixed in different layers with the binder and the conductive additive and arranged in an alternating pattern perpendicular to the anode current collector, and
homogenously mixed in different layers with the binder and the conductive additive and stacked and arranged parallel to the anode current collector.

5. The anode electrode of claim 1, wherein the anode active material layer further comprises a third active material including hard carbon.

6. The anode electrode of claim 5, wherein the first active material, the second active material, and the third active material are one of:
homogenously mixed with binder and a conductive additive in a same layer arranged on the anode current collector,
homogenously mixed in different layers with the binder and the conductive additive and arranged in an alternating pattern perpendicular to the anode current collector, and
homogenously mixed in different layers with the binder and the conductive additive and stacked and arranged parallel to the anode current collector.

7. The anode electrode of claim 3, wherein the first active material comprises 5 wt % to 20 wt % of the active material in the anode active material layer.

8. The anode electrode of claim 3, wherein the first active material comprises 5 wt % to 50 wt % of the active material in the anode active material layer.

9. The anode electrode of claim 3, wherein the first active material comprises 5 wt % to 80 wt % of the active material in the anode active material layer.

10. An anode electrode for a battery cell, comprising:
an anode current collector; and
an anode active material layer comprising:
a first active material comprising silicon; and
a second active material comprising titanium niobium oxide (TNO).

11. The anode electrode of claim 10, wherein the first active material includes one or more materials selected from a group consisting of pure silicon, silicon carbon (SiC) composite, silicon oxide (SiOₓ), lithium silicon oxide (LiSiOₓ), silicon alloy, and combinations thereof.

12. The anode electrode of claim 10, wherein:
the anode active material layer further comprises a binder and a conductive additive, and
the anode active material layer comprises:
active material including the first active material and the second active material in a range from 80% wt to 96% wt of the anode active material layer,
a binder in a range from 2% wt to 10% wt of the anode active material layer, and
a conductive additive in a range from 2% wt to 10% wt of the anode active material layer.

13. The anode electrode of claim 12, wherein the first active material and the second active material are one of:
homogenously mixed with the binder and the conductive additive in a same layer arranged on the anode current collector,
homogenously mixed in different layers with the binder and the conductive additive and arranged in an alternating pattern perpendicular to the anode current collector, and
homogenously mixed in different layers with the binder and the conductive additive and stacked and arranged parallel to the anode current collector.

14. The anode electrode of claim 12, wherein the anode active material layer further comprises:
a third active material including hard carbon; and
a fourth active material comprising graphite.

15. The anode electrode of claim 14, wherein the first active material, the second active material, the third active material, and the fourth active material are one of:
homogenously mixed with the binder and the conductive additive in a same layer arranged on the anode current collector,
homogenously mixed in different layers with the binder and the conductive additive and arranged in an alternating pattern perpendicular to the anode current collector, and
homogenously mixed in different layers with the binder and the conductive additive and stacked and arranged parallel to the anode current collector.

16. The anode electrode of claim 12, wherein the first active material comprises 5 wt % to 80 wt % of the active material in the anode active material layer.

17. An anode electrode for a battery cell, comprising:
an anode current collector; and
an anode active material layer comprising:
a first active material comprising silicon;
a second active material comprising graphite; and
a third active material comprising hard carbon.

18. The anode electrode of claim 17, wherein the first active material includes one or more materials selected from a group consisting of pure silicon, silicon carbon (SiC) composite, silicon oxide (SiOₓ), lithium silicon oxide (LiSiOₓ), silicon alloy, and combinations thereof.

19. The anode electrode of claim 17, wherein:
the anode active material layer further comprises a binder and a conductive additive,
the anode active material layer comprises:
active material including the first active material, the second active material, and the third active material in a range from 80% wt to 96% wt of the anode active material layer,
the binder in a range from 2% wt to 10% wt of the anode active material layer, and
the conductive additive in a range from 2% wt to 10% wt of the anode active material layer, and
the first active material comprises 5% wt to 80% wt of the active material.

20. The anode electrode of claim 17, wherein the first active material, the second active material, and the third active material are one of:
homogenously mixed with a binder and a conductive additive in a same layer arranged on the anode current collector,
homogenously mixed in different layers with the binder and the conductive additive and arranged in an alternating pattern perpendicular to the anode current collector, and
homogenously mixed in different layers with the binder and the conductive additive and stacked and arranged parallel to the anode current collector.
